(19) United States
(12) Patent Application Publication
(10) Pub. No.: US 2020/0256506 A1
(43) Pub. Date: Aug. 13, 2020

(54) METHOD FOR CONTROLLING GIMBAL, GIMBAL, CONTROL SYSTEM, AND MOVABLE DEVICE

(71) Applicant: SZ DJI TECHNOLOGY CO., LTD., Shenzhen (CN)

(72) Inventors: Tie SU, Shenzhen (CN); Paul PAN, Shenzhen (CN)

(21) Appl. No.: 16/860,592

(22) Filed: Apr. 28, 2020

Related U.S. Application Data
(63) Continuation of application No. PCT/CN2017/108267, filed on Oct. 30, 2017.

(51) Int. Cl. F16M 11/12; F16M 11/18; G03B 17/56; G05D 3/20

(52) U.S. Cl. CPC F16M 11/123; F16M 11/18; G08C 17/02; G05D 3/20; G03B 17/561

(57) ABSTRACT

A method for controlling a gimbal includes obtaining a control signal from a remote control corresponding to the gimbal; obtaining first measurement data of a first Inertial Measurement Unit (IMU); and obtaining second measurement data of a second IMU. The first IMU is fixedly connected to a yaw axis arm of the gimbal, and the second IMU is fixedly connected to a pitch axis arm of the gimbal. The method also includes controlling a roll axis pivot mechanism of the gimbal to rotate for any degree in a 360-degree range according to the control signal, the first measurement data, and the second measurement data.

### CROSS-REFERENCE TO RELATED APPLICATION

This application is a continuation of International Application No. PCT/CN2017/108267, filed Oct. 30, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of gimbal and, more particularly, to a method for controlling gimbal, a gimbal, a control system, and a movable device.

### BACKGROUND

A gimbal can provide stability to an object (e.g., a camera) coupled to the gimbal through rotation of its pivot mechanism about three axes, that is, rotation about a yaw axis, a roll axis, and a pitch axis.

In existing technologies, rotation angle about the roll axis of the gimbal is limited by software, which is about ±30°. If no software limit is imposed, the payload of the gimbal can be rotated more than 30° about the roll axis, such as 45° or more, such extent of swaying may prevent the supported camera from performing normal shooting. Thus, gimbals in existing technology do not have the function of being remotely controlled to rotate a payload about the roll axis for 360 degrees.

If a gimbal is used to take some creative revolving shots, such as shooting a racing chase, a user may want to shoot footages from all angles, and each footage corresponding to an angle can be shot from beginning to the end without interruption. In some cases, the user may want to shoot a footage that transitions between the sky and the ground. Fulfilling these user requirements calls for enabling a remote control to control a roll axis pivot mechanism of the gimbal to rotate 360 degrees. Therefore, remotely controlling the roll axis pivot mechanism of the gimbal to rotate 360 degrees has become an urgent technical problem.

### SUMMARY

In accordance with the disclosure, there is provided a method for controlling a gimbal, including obtaining a control signal from a remote control corresponding to the gimbal; obtaining first measurement data of a first Inertial Measurement Unit (IMU); and obtaining second measurement data of a second IMU. The first IMU is fixedly connected to a yaw axis arm of the gimbal, and the second IMU is fixedly connected to a pitch axis arm of the gimbal. The method also includes controlling a roll axis pivot mechanism of the gimbal to rotate for any degree in a 360-degree range according to the control signal, the first measurement data, and the second measurement data.

Also in accordance with the disclosure, there is provided a gimbal including pivot mechanism, a first IMU, a second IMU, and a controller. The pivot mechanism include: a yaw axis arm and a yaw axis motor, configured to facilitate rotation about a yaw axis; a roll axis arm and a roll axis motor, configured to facilitate rotation about a roll axis; and a pitch axis arm and a pitch axis motor, configured to facilitate rotation about a pitch axis. The first IMU is fixedly connected to a yaw axis arm of the gimbal, and the second IMU is fixedly connected to a pitch axis arm of the gimbal. The controller is configured to: obtain a control signal from a remote control corresponding to the gimbal; obtain first measurement data of the first IMU and second measurement data of the second IMU; and control a roll axis pivot mechanism of the gimbal to rotate for any degree in a 360-degree range according to the control signal, the first measurement data, and the second measurement data.

### BRIEF DESCRIPTION OF THE DRAWINGS

FIG. 1 is a schematic diagram of a gimbal according to an example embodiment.

FIG. 2 is a schematic flow chart of a method for controlling a gimbal according to an example embodiment.

FIG. 3 is a flow chart of a gimbal control process according to another example embodiment.

FIG. 4 is a schematic block diagram of a gimbal according to an example embodiment.

FIG. 5 is a schematic block diagram of a control system according to an example embodiment.

FIG. 6 is a schematic diagram of a movable device according to an example embodiment.

### DETAILED DESCRIPTION OF THE EMBODIMENTS

Technical solutions of the present disclosure will be described with reference to the drawings.

It will be appreciated that it is intended that embodiments of the specification are examples only to help those skilled in the art to better understand the present disclosure and not to limit the scope of the present disclosure.

It will also be appreciated that formulas in embodiments of the present disclosure are examples, rather than limiting the scope of the embodiments of the present disclosure. Each formula can be modified, and these modifications should also fall within the scope of the present disclosure.

It will be appreciated that the examples of the specification are merely for the purpose of helping those skilled in the art to understand the embodiments of the present disclosure and are not intended to limit the scope of the present disclosure.

It will also be appreciated that, in various embodiments of the present disclosure, the sequence numbers of each process or step does not indicate the order of execution. The execution order of the processes and steps should be determined by their functions and internal logics, and does not pose any limitation on implementing embodiments of the present disclosure.

It will also be appreciated that the various embodiments described in this specification can be implemented individually or in combination, which is not limited in the present disclosure.

As used herein, when a first component and a second component are referred to as “fixedly connected” or “connected”, or when a first component is referred as being “fixed to” a second component, it is intended that the first component may be directly attached/connected to the second component or may be indirectly attached/connected to the second component via another component.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Technical solutions provided by embodiments of the present disclosure can be applied to various types of gimbals, such as a handheld gimbal. The present disclosure does not limit the type of the gimbal. For example, a gimbal can be set on a movable device. The movable device may be an unmanned aerial vehicle (UAV), an unmanned boat, an autonomous vehicle, or a robot, which is not limited by the present disclosure.

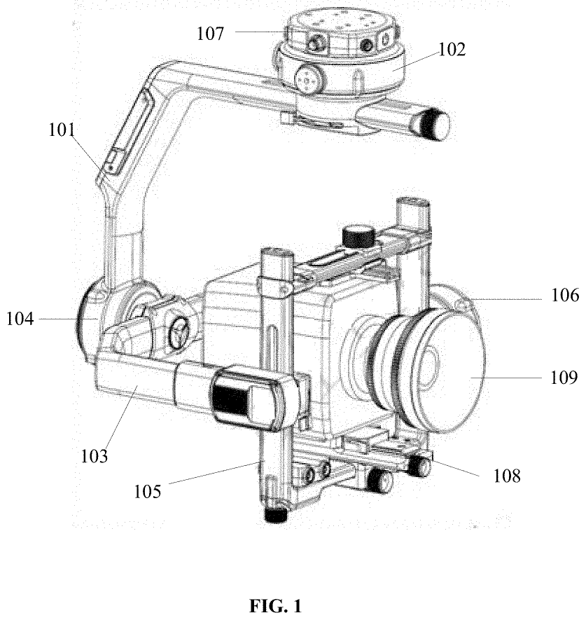

FIG. 1 is a schematic structural diagram of a gimbal according to an example embodiment.

As shown in FIG. 1, an exemplary gimbal may include a yaw axis arm 101, a yaw axis motor 102, a roll axis arm 103, a roll axis motor 104, a pitch axis arm 105, and a pitch axis motor 106, which together constitute the pivot mechanism of the gimbal. Each of the motors 102, 104, and 106 can be controlled by its corresponding Electronic Speed Control (ESC). The yaw axis arm 101 and the yaw axis motor 102 form a yaw axis pivot mechanism and are configured to facilitate rotation (e.g., rotation of a payload) about a yaw axis (e.g., yaw axis of the gimbal); the roll axis arm 103 and the roll axis motor 104 constitute a roll axis pivot mechanism and are configured to facilitate rotation about the roll axis; the pitch axis arm 105 and the pitch axis motor 106 constitute a pitch axis pivot mechanism and are configured to facilitate rotation about the pitch axis. The gimbal can also include a base 107 and a camera fixing mechanism 108. The camera fixing mechanism 108 is configured to fixate a camera 109 and may be fixedly connected to the pitch axis arm 105. The camera 109 can be rotated about the yaw axis, the roll axis, and/or the pitch axis as the pivot mechanism of the gimbal moves/rotates. In some embodiments, the gimbal may further include a controller (not shown in FIG. 1) configured to control the attitude of the gimbal (e.g., the movement/rotation of the pivot mechanism). The controller may be disposed in the camera fixing mechanism 108, and may alternatively be disposed in other positions of the gimbal. The present disclosure does not limit the location of the controller.

In some embodiments, an Inertial Measurement Unit (IMU) is provided in the camera fixing mechanism 108 and is configured to measure the attitude of the gimbal. The controller can be configured to control rotation of the pivot mechanism of the gimbal according to the measurement data of the IMU, to achieve a target attitude. However, when a rotation about the roll axis is above 45°, based on the measurement data of the IMU in the camera fixing mechanism 108 alone, the rotation situations of each axis cannot be determined and remotely controlling a rotation about the roll axis for 360 degrees cannot achieved.

The disclosed gimbal is configured to include an additional IMU, fixedly connected to the yaw axis arm 101 of the gimbal. For example, the additional IMU can be set/configured on/at the Electronic Speed Control (ESC) corresponding to the roll axis motor 104. According to the measurement data of these two IMUs (e.g., the IMU at the camera fixing mechanism 108 and the IMU connected to the yaw axis arm 101), the actual spatial position of the gimbal can be determined, so that the pivot mechanism of the gimbal can be remotely controlled to rotate about the roll axis for any degrees within a 360-degree range. Example embodiments of the present disclosure are described in detail below.

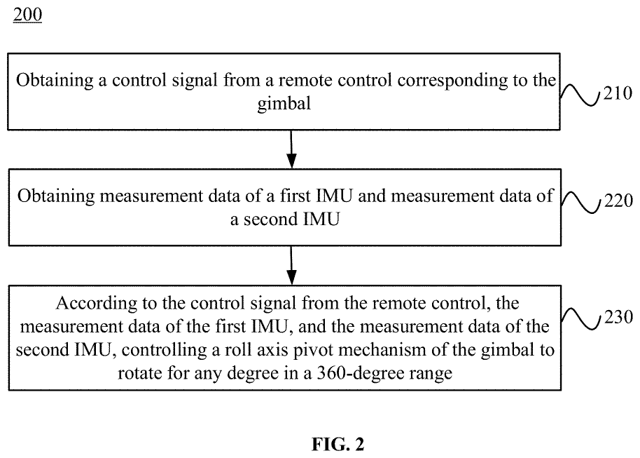

FIG. 2 is a schematic flow chart of a method 200 for controlling a gimbal according to an example embodiment. The method can be implemented by a gimbal (e.g., the gimbal as shown in FIG. 1), a controller in the gimbal, and/or a control system.

At 210, a control signal is obtained from a remote control corresponding to the gimbal.

The control signal provided by the remote control of the gimbal can be used to determine a target spatial position (i.e., a desired spatial position of each axis arm) of the gimbal. Optionally, a target pitch axis angular velocity (e.g., target angular velocity of the pitch axis arm 105 to rotate about the pitch axis), a target roll axis angular velocity, and a target yaw axis angular velocity may be determined according to the control signal from the remote control. The target pitch axis angular velocity, the target roll axis angular velocity, and the target yaw axis angular velocity are respectively integrated to obtain the target spatial position of the gimbal.

In an exemplary embodiment of the present disclosure, the remote control is configured to provide a 360-degree rotation range control on the roll axis pivot mechanism. That is, in the disclosed embodiments, there is no need to limit the rotation range of the pivot mechanism.

Optionally, in one embodiment, the gimbal is configured to provide a Roll_360 mode. The Roll_360 mode indicates that the remote control is able to provide 360-degree-range rotation control of the roll axis pivot mechanism. In this case, the gimbal can be set to work in the Roll_360 mode, and controlled by the remote control.

At 220, measurement data of the first IMU and measurement data of the second IMU are obtained.

In some embodiments, an exemplary gimbal is provided with an additional IMU, i.e., the first IMU. The first IMU is fixedly connected to a yaw axis arm of the exemplary gimbal. Taking the gimbal shown in FIG. 1 as an example, the first IMU is fixedly connected to the yaw axis arm 101 of the gimbal. In one embodiment, the first IMU may be disposed on or together with the ESC corresponding to the roll axis pivot mechanism. The actual placement of the first IMU is not limited by the present disclosure. The second IMU is fixedly connected to a pitch axis arm of the exemplary gimbal. Taking the gimbal shown in FIG. 1 as an example, the second IMU is fixedly connected to the pitch axis arm 105 of the gimbal. In one embodiment, the second IMU may be disposed inside the camera fixing mechanism 108 or the camera 109. The actual placement of the second IMU is not limited by the present disclosure.

Optionally, the measurement data of the first IMU may include a yaw axis angular velocity of the gimbal, and the measurement data of the second IMU may include a pitch axis angular velocity and a roll axis angular velocity of the gimbal. That is, the angular velocity about the yaw axis of the gimbal can be obtained through the first IMU, and the angular velocities about the pitch axis and the roll axis of the gimbal can be obtained through the second IMU.

Optionally, the first IMU may include a gyroscope, and the yaw axis angular velocity is obtained through the gyroscope. The first IMU may also include other measurement units, which is not limited in the present disclosure.

Optionally, the second IMU may include a gyroscope, and the pitch axis angular velocity and the roll axis angular velocity are obtained through the gyroscope. The second IMU may also include other measurement units, which is not limited in the present disclosure.

The yaw axis angular velocity, the pitch axis angular velocity, and the roll axis angular velocity of the gimbal are obtained by using the first IMU and the second IMU. The spatial position of the gimbal can be obtained based on the angular velocities about respective axes.

At 230, according to the control signal from the remote control, the measurement data of the first IMU and the measurement data of the second IMU, the pivot mechanism of the gimbal is controlled to rotate about the roll axis for any degree within a 360-degree range. In other words, the roll axis pivot mechanism of the gimbal is controlled to rotate for any degree within a 360-degree range.

In some embodiments, according to the measurement data of the newly added first IMU and the measurement data of the second IMU, the rotation angle of the pivot mechanism of the gimbal about each axis can be obtained. In this way, no matter how great the target angle of rotation about the roll axis is, the rotation angle about each axis can be determined, so that the remote control can be used to control the pivot mechanism to rotate about the roll axis for any angle.

Optionally, in one embodiment, a target spatial position of the gimbal may be determined according to the control signal of the remote control. An actual spatial position of the gimbal (e.g., current position of each axis arm) is determined according to the measurement data of the first IMU and the second IMU. The pivot mechanism of the gimbal is controlled to rotate about the roll axis at any degree within a range of 360 degrees according to the target spatial position and the actual spatial position.

Optionally, in one embodiment, the actual spatial position of the gimbal may be determined according to the pitch axis angular velocity, the roll axis angular velocity, and the yaw axis angular velocity.

Optionally, in one embodiment, the pitch axis angular velocity, the roll axis angular velocity, and the yaw axis angular velocity can be respectively integrated to obtain the rotation angle about each axis, thereby determining the actual spatial position of the gimbal.

Optionally, in one embodiment, each angular velocity may be calibrated before being integrated.

Specifically, there may be a drift/bias in data outputted from the first and/or second IMU. In this case, each angular velocity acquired by the IMUs can be calibrated before integration. For example, the yaw axis angular velocity may be calibrated according to a bias corresponding to the yaw axis to obtain calibrated yaw axis angular velocity; the pitch axis angular velocity may be calibrated according to a bias corresponding to the pitch axis to obtain calibrated pitch axis angular velocity; and the roll axis angular velocity may be calibrated according to a bias corresponding to the roll axis to obtain calibrated roll axis angular velocity. The calibrated pitch axis angular velocity, the calibrated roll axis angular velocity, and the calibrated yaw axis angular velocity are then respectively integrated to obtain the actual spatial location of the gimbal.

Optionally, a bias corresponding to a specific axis may be corrected according to a joint angle corresponding to the specific axis. The joint angle corresponding to the specific axis can be obtained by a motor angle measurement unit corresponding to the specific axis. The specific axis may be the yaw axis, the roll axis, and/or the pitch axis of the gimbal.

Specifically, the bias corresponding to a specific axis may change with time. In this case, the bias also needs to be corrected. The correction of the bias corresponding to a specific axis can utilize measurement data of a corresponding motor angle measurement unit. The motor angle measurement unit (such as a Hall effect sensor) can be configured to measure the joint angle corresponding to the specific axis. Based on the data of the motor angle measurement unit, the above-mentioned bias can be corrected.

Optionally, based on a currently measured joint angle of a specific axis, a previously measured joint angle corresponding to the specific axis (e.g., measured last time by the motor angle measuring unit corresponding to the specific axis) and the measurement frequency, a reference angular velocity about the specific axis can be determined. The correction amount of the bias for the specific axis can be determined according to the reference angular velocity about the specific axis and a calibrated angular velocity about the specific axis. The bias for the specific axis is corrected based on the correction amount of the bias for the specific axis.

For example, the correction amount of the bias for the specific axis is denoted as omega_bias+, and can be determined based on the following equations.

omega_calibrate=omega_raw−omega_bias

omega_reference=(joint_angle−joint_angle_last)*freq

omega_bias+=(omega_reference−omega_calibrate)*bias_calibrate_coefficient

Here, omega_raw represents an initial angular velocity about a specific axis measured by the IMU, omega_bias represents the bias for the specific axis, omega_calibrate represents the calibrated angular velocity, omega_reference represents the reference angular velocity, joint_angle represents the current joint angle measured by the motor angle measurement unit, and joint_angle_last represents the joint angle measured by the motor angle measurement unit last time, freq represents measurement frequency of the motor angle measurement unit, and bias_calibrate_coefficient represents a bias correction coefficient.

The correction amount of the bias omega_bias+ can be used to correct the bias omega_bias. For example, omega_bias is a real-time integration of (omega_reference−omega_calibrate)*bias_calibrate_coefficient. The corrected bias omega_bias can be used for next calibration, i.e., used to determine omega_calibrate in a following/next time.

According to the target spatial position obtained from the control signal of the remote control and the actual spatial position obtained from the measurement data of the IMUs, each axis pivot mechanism of the gimbal can be controlled to rotate within 360 degrees to adjust the actual spatial position of the gimbal to reach the target spatial position.

In one embodiment, a motor control signal may be determined according to a difference between the target spatial position and the actual spatial position. According to the motor control signal, a yaw axis motor, a pitch axis motor, and a roll axis motor of the gimbal are controlled to rotate their corresponding arms about the yaw, pitch, and/or roll axes within a range of 360 degrees, so that the spatial position of the gimbal changes to the target spatial position.

From the difference between the target space position and the actual space position, the angles that each axis pivot mechanism needs to be rotated can be obtained, and the motor control signal can be generated accordingly. The motors corresponding to each axis are controlled to rotate the pivot mechanism of the gimbal towards the target spatial position.

Optionally, the generation of the control signal may be further implemented by combining the difference between a target angular velocity and an actual angular velocity. For example, the target angular velocity about each axis is obtained from the difference between the target spatial position and the actual spatial position, and the motor control signal of each axis is generated based on the difference between the target angular velocity and the actual angular velocity.

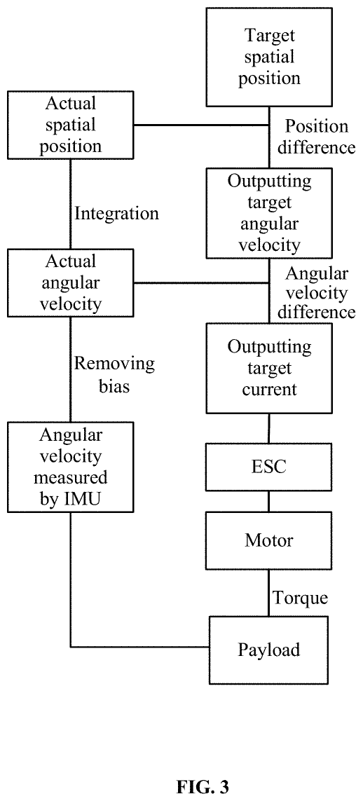

FIG. 3 is a schematic flow chart of a gimbal control process according to another example embodiment. It should be understood that FIG. 3 is merely an example, and should not be construed as limiting embodiments of the present disclosure.

As shown in FIG. 3, calibrated angular velocities (i.e., actual angular velocities) are obtained by subtracting bias from initial angular velocities measured by IMUS (e.g., the above-mentioned first IMU and second IMU). The actual spatial position of the gimbal is obtained from integrating the calibrated angular velocities. On the other hand, target spatial position of the gimbal can be obtained from a control signal of the remote control. Target angular velocities can be obtained based on the difference between the target spatial position and the actual spatial position. The ESC controls the motor according to the motor control signal, so that the rotation axis of the gimbal rotates within 360 degrees, thereby reaching the target spatial position.

Besides fixedly connecting an IMU to the pitch axis arm, a technical solution provided by the present disclosure includes fixedly connecting another IMU to the yaw axis arm, such that no matter how great the angle of rotation about the roll axis is, the rotation angles about all axes can be determined based on the measurement data of the IMUs, thereby accurately controlling the rotation of the pivot mechanism of the gimbal. In this way, using a remote control to control the roll axis pivot mechanism of the gimbal to rotate for any degree in a 360-degree range can be achieved.

Example gimbal control methods consistent with the disclosure are described above in detail. Example gimbal, control system and movable device consistent with the disclosure will be described in detail below. The example gimbal, control system, and/or movable device consistent with the disclosure can be configured to perform a method consistent with the disclosure, such as one of the example methods described above. Therefore, reference can be made to the above-described example methods for detailed operations of the example devices described below.

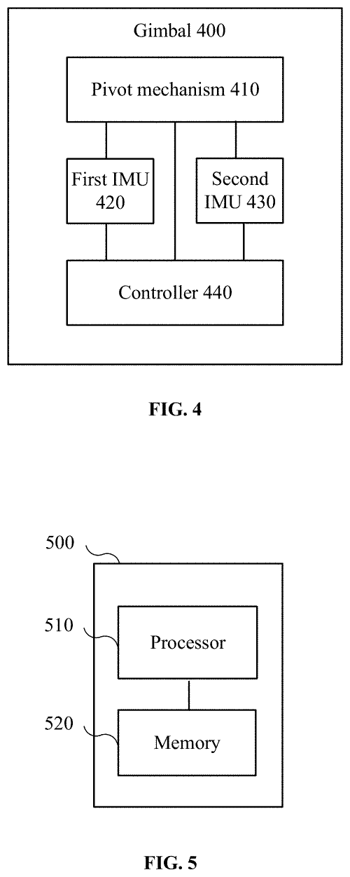

FIG. 4 is a schematic block diagram of a gimbal 400 according to an example embodiment.

The gimbal 400 can adopt the structure of the gimbal shown in FIG. 1, or any other proper structure, which is not limited by the present disclosure.

As shown in FIG. 4, the gimbal 400 includes: a pivot mechanism 410, a first IMU 420, a second IMU 430, and a controller 440.

The pivot mechanism 410 may include: a yaw axis arm and a yaw axis motor, configured to facilitate rotation about a yaw axis; a roll axis arm and a roll axis motor, configured to facilitate rotation about a roll axis; and a pitch axis arm and a pitch axis motor, configured to facilitate rotation about a pitch axis.

The first IMU 420 is fixedly connected to a yaw axis arm of the gimbal.

The second IMU 430 is fixedly connected to a pitch axis arm of the gimbal.

The controller 440 is configured to: obtain a control signal from a remote control corresponding to the gimbal; obtain first measurement data of the first IMU 420 and second measurement data of the second IMU 430; and control a roll axis pivot mechanism (e.g. roll axis arm) of the gimbal to rotate for any degree in a 360-degree range according to the control signal, the first measurement data, and the second measurement data.

The disclosed gimbal not only includes an IMU that is fixedly connected to the pitch axis arm of the gimbal, but also includes another IMU that is fixedly connected to the yaw axis arm of the gimbal. In this way, no matter how great the angle of rotation about the roll axis is, the rotation angles about all axes can be determined based on the measurement data of the IMUS, thereby accurately controlling the rotation of the gimbal. In this way, using a remote control to control the gimbal to rotate about the roll axis within 360 degrees can be achieved.

Optionally, in one embodiment, the controller 440 is specifically configured to: determine a target spatial position of the gimbal according to the control signal from the remote control; determine an actual spatial position of the gimbal according to the measurement data from the first IMU 420 and the second IMU 430; and control the roll axis pivot mechanism of the gimbal to rotate for any degree in the 360-degree range according to the target spatial position and the actual spatial position.

Optionally, in one embodiment, the measurement data of the first IMU 420 includes a yaw axis angular velocity (e.g., angular velocity of the yaw axis arm). The measurement data of the second IMU 430 includes a roll axis angular velocity and a pitch axis angular velocity. The controller 440 is specifically configured to determine the actual spatial position of the gimbal according to the yaw axis angular velocity, the roll axis angular velocity and the pitch axis angular velocity.

Optionally, in one embodiment, the controller 440 is specifically configured to: calibrate the yaw axis angular velocity according to a yaw axis bias, to obtain a calibrated yaw axis angular velocity; calibrate the pitch axis angular velocity according to a pitch axis bias, to obtain a calibrated pitch axis angular velocity; calibrate the roll axis angular velocity according to a roll axis bias, to obtain a calibrated roll axis angular velocity; and respectively perform integration on the calibrated yaw axis angular velocity, the calibrated roll axis angular velocity and the calibrated pitch axis angular velocity, to obtain the actual spatial position of the gimbal.

Optionally, in one embodiment, the controller 440 is further configured to: correct a bias corresponding to a specific axis according to a joint angle of a pivot mechanism corresponding to the specific axis, the joint angle being obtained by a motor angle measurement unit corresponding to the specific axis, the specific axis being at least one of the yaw axis, the pitch axis, or the roll axis of the gimbal.

Optionally, in one embodiment, the controller 440 is specifically configured to: determine a reference angular velocity about the specific axis according to a current joint angle measured by the motor angle measurement unit corresponding to the specific axis, a previous joint angle measured by the motor angle measurement unit corresponding to the specific axis last time, and a measurement frequency; determine a correction amount of the bias corresponding to the specific axis according to the reference angular velocity about the specific axis and a calibrated angular velocity about the specific axis; and correct the bias corresponding to the specific axis according to the correction amount.

Optionally, in one embodiment, the controller 440 is further configured to: set the gimbal to operate at a roll_360 mode, the roll_360 mode indicating that the remote control is enabled to control the roll axis pivot mechanism of the gimbal to rotate for any degree in the 360-degree range.

Optionally, in one embodiment, the controller 440 is further configured to: determine a target yaw axis angular velocity, a target roll axis angular velocity and a target pitch axis angular velocity according to the control signal from the remote control; and respectively integrate the target yaw axis angular velocity, the target roll axis angular velocity and the target pitch axis angular velocity, to obtain the target spatial position of the gimbal.

Optionally, in one embodiment, the controller 440 is specifically configured to: determine a motor control signal according to a difference between the target spatial position and the actual spatial position; and control, according to the motor control signal, the roll axis motor, the pitch axis motor, and the yaw axis motor of the gimbal to rotate at least one of the roll axis pivot mechanism, a pitch axis pivot mechanism, or a yaw axis pivot mechanism for any degree in the 360-degree range, and to adjust the gimbal from the actual spatial position towards the target spatial position.

Optionally, in one embodiment, the first IMU 420 is disposed on an Electronic Speed Control (ESC) of the roll axis pivot mechanism of the gimbal; and the second IMU 430 is disposed inside a camera fixing mechanism of the gimbal.

Optionally, in one embodiment, the first IMU 420 and the second IMU 430 each include a gyroscope.

The present disclosure does not limit specific implementation form of the controller 440. In some embodiments, the controller 440 may be a processor, a chip, or a motherboard, which is not limited herein.

FIG. 5 is a schematic block diagram of a control system 500 according to an example embodiment.

As shown in FIG. 5, the control system 500 may include a processor 510 and a memory 520.

In some embodiments, the control system 500 may further include common components in other computer systems, such as a communication interface, which is not limited in the present disclosure.

The memory 520 is configured to store computer-executable instructions.

The memory 520 may be various types of memory, and is not limited in the present disclosure. For example, the memory 520 may include a high-speed random access memory (RAM), and/or a non-volatile memory such as at least one disk memory.

The processor 510 is configured to access the memory 520 and execute the computer-executable instructions to perform operations in the methods of various embodiments described above.

The processor 510 may include a microprocessor, a Field-Programmable Gate Array (FPGA), a Central Processing Unit (CPU), a Graphics Processing Unit (GPU), and/or the like, which is not limited in the present disclosure.

The present disclosure further provides a movable device. The movable device may include the gimbal and/or the control system consistent with embodiments described above.

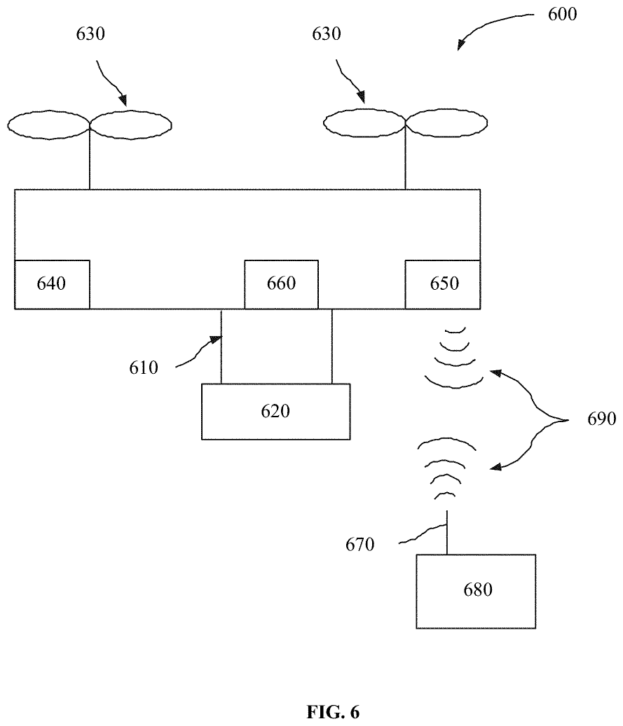

FIG. 6 is a schematic diagram of a movable device 600 according to an example embodiment. As shown in FIG. 6, the movable device 600 may include a gimbal 610 and a camera 620. The camera 620 is connected to the movable device 600 via the gimbal 610.

Using a UAV as an example, the movable device 600 can also include a propulsion system 630, a sensing system 640, a communication system 650, and an image processing device 660. It should be understood that the description of the movable device as a UAV in FIG. 6 is merely for the purpose of description.

The propulsion system 630 may include one or more ESCs, one or more propellers, and one or more electric motors each corresponding to one of the one or more propellers. A pair of a motor and a propeller is arranged on a corresponding arm of the UAV. An ESC is configured to receive a driving signal generated by a flight controller of the UAV and provide a driving current to its corresponding motor according to the driving signal to control the speed and/or rotation direction of the motor. The one or more motors are configured to drive the one or more propellers to rotate, thereby providing a driving power for the UAV to fly. The driving power enables the UAV to move with one or more degrees of freedom. In some embodiments, the UAV may rotate about one or more axes of rotation. For example, the rotation axes may include a roll axis, a yaw axis, and a pitch axis. It should be understood that each of the one or more motors may be a direct current (DC) motor or an alternating current (AC) motor. In addition, each of the one or more motors may be a brushless motor or a brushed motor.

The sensing system 640 is configured to measure attitude information of the UAV. The attitude information may include position information and status information of the UAV in space, such as three-dimensional position, three-dimensional angle, three-dimensional velocity/speed, three-dimensional acceleration, and/or three-dimensional angular speed/velocity. The sensing system 640 may include at least one of a gyroscope, an electronic compass, an inertial measurement unit, a vision sensor, a Global Positioning System (GPS), or a barometer. The flight controller is configured to control the flight of the UAV, such as controlling the flight of the UAV according to the attitude information measured by the sensing system 640. It should be understood that the flight controller may control the UAV according to a pre-programmed instruction, and may also control the UAV by responding to one or more control instructions from a control device.

The communication system 650 is configured to communicate with a terminal device 680 having a communication system 670 through a wireless signal 690. The communication system 650 and the communication system 670 may include a plurality of transmitters, receivers, and/or transceivers for wireless communication. The wireless communication may be a one-way communication. For example, the UAV can only send data to the terminal device 680. Alternatively, the wireless communication may be two-way communication, where data can be sent from the UAV to the terminal device 680, and can also be sent from the terminal device 680 to the UAV.

Optionally, the terminal device 680 is configured to provide control data for one or more UAVs, the gimbal 610, and the camera 620, and to receive information sent by the one or more UAVs, the gimbal 610, and the camera 620. The control data provided by the terminal device 680 can be used to control the status of one or more UAVs, the gimbal 610, and the camera 620. Optionally, the gimbal 610 and/or the camera 620 include a communication module for communicating with the terminal device 680.

For simplification purposes, detailed descriptions of the gimbal 610 shown in FIG. 6 may be omitted and references can be made to the descriptions of the gimbal discussed in foregoing examples.

It should be understood that the foregoing division and naming of each component of the movable device 600 is merely illustrative, and should not be construed as limiting the scope of the present disclosure.

It should also be understood that the movable device 600 may further include other components not shown in FIG. 6, which is not limited herein.

The gimbal, the control system, and/or the movable device discussed in the embodiments may be the execution entity of the gimbal controlling method discussed in the foregoing examples. Operation and/or functions of various components of the gimbal, the control system, and/or the movable device are respectively used to implement the corresponding processes of the foregoing methods, and corresponding descriptions are omitted for simplification purposes.

The present disclosure further provides a computer storage medium. The computer storage medium stores program code, and the program code may be used to instruct a processor to execute the method for controlling a gimbal according to the foregoing embodiments.

In the present disclosure, the term “and/or” merely describes an association relationship between associated objects, and may indicate three possible relationships. For example, A and/or B can indicate three situations: A alone, A and B, and B alone. In addition, the character “/” in the present disclosure generally indicates that the related objects have an “or” relationship.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, devices, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The integrated units can be implemented in the form of hardware or software functional units.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for controlling a gimbal, comprising:
obtaining a control signal from a remote control corresponding to the gimbal;
obtaining first measurement data of a first Inertial Measurement Unit (IMU), the first IMU being fixedly connected to a yaw axis arm of the gimbal;
obtaining second measurement data of a second IMU, the second IMU being fixedly connected to a pitch axis arm of the gimbal; and
controlling a roll axis pivot mechanism of the gimbal to rotate for any degree in a 360-degree range according to the control signal, the first measurement data, and the second measurement data.

2. The method of claim 1, wherein controlling the roll axis pivot mechanism of the gimbal to rotate for any degree in the 360-degree range comprises:
determining a target spatial position of the gimbal according to the control signal from the remote control;
determining an actual spatial position of the gimbal according to the first measurement data and the second measurement data; and
controlling the roll axis pivot mechanism of the gimbal to rotate for any degree in the 360-degree range according to the target spatial position and the actual spatial position.

3. The method of claim 2, wherein:
the first measurement data of the first IMU comprises a yaw axis angular velocity;
the second measurement data of the second IMU comprises a roll axis angular velocity and a pitch axis angular velocity; and
determining the actual spatial position of the gimbal according to the first measurement data and the second measurement data comprises: determining the actual spatial position of the gimbal according to the yaw axis angular velocity, the roll axis angular velocity and the pitch axis angular velocity.

4. The method of claim 3, wherein determining the actual spatial position of the gimbal according to the yaw axis angular velocity, the roll axis angular velocity and the pitch axis angular velocity comprises:
calibrating the yaw axis angular velocity according to a yaw axis bias, to obtain a calibrated yaw axis angular velocity;
calibrating the pitch axis angular velocity according to a pitch axis bias, to obtain a calibrated pitch axis angular velocity;
calibrating the roll axis angular velocity according to a roll axis bias, to obtain a calibrated roll axis angular velocity; and
respectively performing integration on the calibrated yaw axis angular velocity, the calibrated roll axis angular velocity and the calibrated pitch axis angular velocity, to obtain the actual spatial position of the gimbal.

5. The method of claim 4, further comprising:
correcting a bias corresponding to a specific axis according to a joint angle of a pivot mechanism corresponding to the specific axis, the joint angle being obtained by a motor angle measurement unit corresponding to the specific axis, the specific axis being at least one of the yaw axis, the pitch axis, or the roll axis of the gimbal.

6. The method of claim 5, wherein correcting the bias corresponding to the specific axis comprises:
determining a reference angular velocity about the specific axis according to a current joint angle measured by the motor angle measurement unit corresponding to the specific axis, a previous joint angle measured by the motor angle measurement unit corresponding to the specific axis last time, and a measurement frequency;
determining a correction amount of the bias corresponding to the specific axis according to the reference angular velocity about the specific axis and a calibrated angular velocity about the specific axis; and
correcting the bias corresponding to the specific axis according to the correction amount.

7. The method of claim 1, further comprising: before obtaining the control signal from the remote control,
setting the gimbal to operate at a roll_360 mode, the roll_360 mode indicating that the remote control is enabled to control the roll axis pivot mechanism of the gimbal to rotate for any degree in the 360-degree range.

8. The method of claim 2, wherein determining a target spatial position of the gimbal according to the control signal comprises:
determining a target yaw axis angular velocity, a target roll axis angular velocity and a target pitch axis angular velocity according to the control signal from the remote control;
respectively integrating the target yaw axis angular velocity, the target roll axis angular velocity and the target pitch axis angular velocity, to obtain the target spatial position of the gimbal.

9. The method of claim 2, wherein controlling the roll axis pivot mechanism of the gimbal to rotate for any degree in the 360-degree range according to the target spatial position and the actual spatial position comprises:
determining a motor control signal according to a difference between the target spatial position and the actual spatial position; and
controlling, according to the motor control signal, a roll axis motor, a pitch axis motor, and a yaw axis motor of the gimbal to rotate at least one of the roll axis pivot mechanism, a pitch axis pivot mechanism, or a yaw axis pivot mechanism for any degree in the 360-degree range, and to adjust the gimbal from the actual spatial position towards the target spatial position.

10. The method of claim 1, wherein:
the first IMU is disposed on an Electronic Speed Control (ESC) of the roll axis pivot mechanism of the gimbal; and
the second IMU is disposed inside a camera fixing mechanism of the gimbal.

11. The method of claim 1, wherein:
the first IMU and the second IMU both comprise a gyroscope.

12. A gimbal, comprising:
a pivot mechanism, comprising:
a yaw axis arm and a yaw axis motor, configured to facilitate rotation about a yaw axis;
a roll axis arm and a roll axis motor, configured to facilitate rotation about a roll axis; and
a pitch axis arm and a pitch axis motor, configured to facilitate rotation about a pitch axis;
a first Inertial Measurement Unit (IMU), fixedly connected to the yaw axis arm;
a second IMU, fixedly connected to the pitch axis arm; and
a controller, configured to:
obtain a control signal from a remote control corresponding to the gimbal;
obtain first measurement data of the first IMU and second measurement data of the second IMU; and
control a roll axis pivot mechanism of the gimbal to rotate for any degree in a 360-degree range according to the control signal, the first measurement data, and the second measurement data.

13. The gimbal of claim 12, wherein the controller is further configured to:
determine a target spatial position of the gimbal according to the control signal from the remote control;
determine an actual spatial position of the gimbal according to the first measurement data and the second measurement data; and
control the roll axis pivot mechanism of the gimbal to rotate for any degree in the 360-degree range according to the target spatial position and the actual spatial position.

14. The gimbal of claim 13, wherein:
the first measurement data of the first IMU comprises a yaw axis angular velocity;
the second measurement data of the second IMU comprises a roll axis angular velocity and a pitch axis angular velocity; and
the controller is further configured to determine the actual spatial position of the gimbal according to the yaw axis angular velocity, the roll axis angular velocity and the pitch axis angular velocity.

15. The gimbal of claim 14, wherein the controller is further configured to:
calibrate the yaw axis angular velocity according to a yaw axis bias, to obtain a calibrated yaw axis angular velocity;
calibrate the pitch axis angular velocity according to a pitch axis bias, to obtain a calibrated pitch axis angular velocity;
calibrate the roll axis angular velocity according to a roll axis bias, to obtain a calibrated roll axis angular velocity; and
respectively perform integration on the calibrated yaw axis angular velocity, the calibrated roll axis angular velocity and the calibrated pitch axis angular velocity, to obtain the actual spatial position of the gimbal.

16. The gimbal of claim 15, wherein the controller is further configured to:
correct a bias corresponding to a specific axis according to a joint angle of a pivot mechanism corresponding to the specific axis, the joint angle being obtained by a motor angle measurement unit corresponding to the specific axis, the specific axis being at least one of the yaw axis, the pitch axis, or the roll axis of the gimbal.

17. The gimbal of claim 16, wherein the controller is further configured to:
determine a reference angular velocity about the specific axis according to a current joint angle measured by the motor angle measurement unit corresponding to the specific axis, a previous joint angle measured by the motor angle measurement unit corresponding to the specific axis last time, and a measurement frequency;
determine a correction amount of the bias corresponding to the specific axis according to the reference angular velocity about the specific axis and a calibrated angular velocity about the specific axis; and
correct the bias corresponding to the specific axis according to the correction amount.

18. The gimbal of claim 12, wherein the controller is further configured to:
set the gimbal to operate at a roll_360 mode, the roll_360 mode indicating that the remote control is enabled to control the roll axis pivot mechanism of the gimbal to rotate for any degree in the 360-degree range.

19. The gimbal of claim 13, wherein the controller is further configured to:
determine a target yaw axis angular velocity, a target roll axis angular velocity and a target pitch axis angular velocity according to the control signal from the remote control; and
respectively integrate the target yaw axis angular velocity, the target roll axis angular velocity and the target pitch axis angular velocity, to obtain the target spatial position of the gimbal.

20. The gimbal of claim 13, wherein the controller is further configured to:
determine a motor control signal according to a difference between the target spatial position and the actual spatial position; and
control, according to the motor control signal, the roll axis motor, the pitch axis motor, and the yaw axis motor of the gimbal to rotate at least one of the roll axis pivot mechanism, a pitch axis pivot mechanism, or a yaw axis pivot mechanism for any degree in the 360-degree range, and to adjust the gimbal from the actual spatial position towards the target spatial position.

21. The gimbal of claim 12, wherein:
the first IMU is disposed on an Electronic Speed Control (ESC) of the roll axis pivot mechanism of the gimbal; and
the second IMU is disposed inside a camera fixing mechanism of the gimbal.
